(19) United States
(12) Patent Application Publication
(10) Pub. No.: US 2009/0162546 A1
(43) Pub. Date: Jun. 25, 2009

(54) System, formulation and method for producing ceramic vacuum microspheres

(76) Inventor: Bo H. Gimvang, South Daytona, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/317,155

(22) Filed: Dec. 19, 2008

Related U.S. Application Data
(60) Provisional application No. 61/015,103, filed on Dec. 19, 2007.

(51) Int. Cl. B05D 7/00

(52) U.S. Cl. 427/215

(57) ABSTRACT

A system, formulation and method for producing ceramic vacuum microspheres utilizing a spray dryer having a top mounted atomizer rotary wheel and a side or bottom mounted dual fluid nozzle, forming microspheres by spraying solution from the top mounted atomizer rotary wheel and simultaneously coating the microspheres by spraying solution from the side or bottom mounted dual fluid nozzle, transferring the microspheres to a secondary heating unit, and drying the microspheres, all under vacuum of between 1 to 5 millibars.

This application claims the benefit of U.S. Provisional Patent application Ser. No. 61/015,103, filed Dec. 19, 2007.

### BACKGROUND

There is a need in the art for a system and method of producing ceramic microspheres for use in the recreational, pharmaceutical and cosmetics industries. In particular, there is a need in the art for a system and method of producing ceramic microspheres wherein the resulting product is substantially clear, uniformly-sized, less water soluble and resistant to crushing.

### DETAILED DESCRIPTION

In one embodiment, the present invention includes a system for producing ceramic microspheres including a dual-stage drying apparatus. The drying apparatus is adapted to receive a formulation and process the formulation according to a predetermined protocol in order to create ceramic microspheres, which may include a substantially vacuous interior, i.e. ceramic vacuum microspheres.

The system can include a first stage dryer having an input portion and an output portion. The inlet portion receives a raw formulation, and the outlet portion expels the resultant microsphere product into a second stage, described in more detail below. The first stage dryer can include for example a spray dryer having a dual fluid nozzle or atomizing centrifugal wheel adapted for receiving a liquid formulation and distributing it substantially uniformly throughout the interior, heated portion of the first stage dryer. In one variation of the system, the first stage dryer can have an inlet temperature ranging between two hundred fifty and five hundred degrees Celsius. The outlet portion temperature can range between eighty and one hundred fifty degrees Celsius. Other suitable temperature ranges are also anticipated by the present invention, provided that the output product of the first stage dryer is sufficiently formed in order to be further processed in the second stage dryer.

The system can further include a second stage dryer that can be connected to the outlet portion of the first stage dryer. The second stage dryer can include for example a rotary kiln furnace, a tube furnace, a rotary tube furnace, or any other suitable heating means or mechanism. The second stage dryer can include one or more temperature zones, within which the temperature can range anywhere between two hundred degrees Celsius and one thousand seven hundred degrees Celsius. For example, the second stage dryer can have a first zone at a feed inlet having a temperature between three hundred and five hundred degrees Celsius, a second zone having a temperature between four hundred and eight hundred degrees Celsius, and a third zone having a temperature between two hundred and four hundred degrees Celsius.

Typical ceramic microsphere production involves a single stage machine or dryer. The resultant products are certainly usable in many industries, but not generally of the highest grade or quality. In order to improve the density factor as well as the crushing strength of the microspheres, the system of the preferred embodiment can employ a second drying (heating) stage. First order microspheres can be input into the second stage dryer manually or through automated machines and/or processes. Using a second drying stage imparts a number of benefits on the end product. For example, a typical first order microsphere contains between ten and eighteen percent moisture, which in turn decreases the strength of the microspheres and increases the chances of them being water soluble. By using the second stage drying process disclosed herein, the final product will have little to no moisture content, thereby increasing the strength, water-imperviousness, clarity and functionality of the ceramic vacuum microspheres.

The system of the preferred embodiment and variations thereof is adapted to produce the ceramic vacuum microspheres in response to the input of at least the following example formulations, or any combination thereof.

A first example formulation includes sodium silicate, boric acid and urea. In one variation of the first example formulation, the formulation is approximately seventy eight percent sodium silicate by weight, approximately three percent boric acid by weight via a three percent solution in water, and approximately nineteen percent urea by weight via a thirty percent solution in water. In another variation of the first example formulation, the formulation is between seventy and eighty five percent sodium silicate by weight, between zero (trace) and five percent boric acid by weight and between fifteen and thirty percent urea by weight. Other suitable silicates can include lithium silicate, potassium silicate, or any other alkali metal-silicate suitable for creating ceramic vacuum microspheres.

A second example formulation includes sodium silicate, potassium methyl silicate, boric acid and urea. In one variation of the second example formulation, the formulation is approximately seventy two percent sodium silicate by weight, approximately six percent potassium methyl siliconate by weight, approximately three percent boric acid by weight via a three percent solution in water, and approximately nineteen percent urea by weight via a thirty percent solution in water. In another variation of the second example formulation, the formulation is between sixty and seventy five percent sodium silicate by weight, between zero (trace) and ten percent potassium methyl siliconate by weight, between zero (trace) and five percent boric acid by weight and between fifteen and thirty percent urea by weight. As noted above, other suitable silicates can include lithium silicate, potassium silicate, or any other alkali metal-silicate suitable for creating ceramic vacuum microspheres.

A third example formulation includes potassium silicate, boric acid and urea. In one variation of the third example formulation, the formulation is approximately seventy eight percent potassium silicate by weight, approximately three percent boric acid by weight via a three percent solution in water, and approximately nineteen percent urea by weight via a thirty percent solution in water. In another variation of the third example formulation, the formulation is between seventy and eighty five percent potassium silicate by weight, between zero (trace) and five percent boric acid by weight and between fifteen and thirty percent urea by weight. Other suitable silicates can include lithium silicate, sodium silicate, or any other alkali metal-silicate suitable for creating ceramic vacuum microspheres.

A fourth example formulation includes potassium silicate, potassium methyl silicate, boric acid and urea. In one variation of the fourth example formulation, the formulation is approximately seventy two percent potassium silicate by weight, approximately six percent potassium methyl siliconate by weight, approximately three percent boric acid by weight via a three percent solution in water, and approximately nineteen percent urea by weight via a thirty percent solution in water. In another variation of the fourth example formulation, the formulation is between sixty and seventy five percent potassium silicate by weight, between zero (trace) and ten percent potassium methyl siliconate by weight, between zero (trace) and five percent boric acid by weight and between fifteen and thirty percent urea by weight. As noted above, other suitable silicates can include lithium silicate, sodium silicate, or any other alkali metal-silicate suitable for creating ceramic vacuum microspheres.

A fifth example formulation includes lithium silicate, boric acid and urea. In one variation of the fifth example formulation, the formulation is approximately eighty percent lithium silicate by weight, approximately two percent boric acid by weight via a three percent solution in water, and approximately eighteen percent urea by weight via a thirty percent solution in water. In another variation of the fifth example formulation, the formulation is between seventy and eighty five percent lithium silicate by weight, between zero (trace) and five percent boric acid by weight and between fifteen and thirty percent urea by weight. Other suitable silicates can include sodium silicate, potassium silicate, or any other alkali metal-silicate suitable for creating ceramic vacuum microspheres.

A sixth example formulation includes lithium silicate, potassium methyl silicate, boric acid and urea. In one variation of the fourth example formulation, the formulation is approximately eighty percent lithium silicate by weight, approximately six percent potassium methyl siliconate by weight, approximately two percent boric acid by weight via a three percent solution in water, and approximately twelve percent urea by weight via a thirty percent solution in water. In another variation of the sixth example formulation, the formulation is between seventy and ninety percent lithium silicate by weight, between zero (trace) and ten percent potassium methyl siliconate by weight, between zero (trace) and three percent boric acid by weight and between eight and sixteen percent urea by weight. As noted above, other suitable silicates can include potassium silicate, sodium silicate, or any other alkali metal-silicate suitable for creating ceramic vacuum microspheres.

A seventh example formulation includes an alkali silicate, a non-ionic fluorocarbon surfactant, potassium carbonate, hydrogen peroxide and boric acid. In one variation of the seventh example formulation, the formulation is approximately seventy two percent alkali silicate by weight, approximately five tenths of a percent non-ionic fluorocarbon surfactant by weight, approximately three percent potassium carbonate by weight, approximately twenty one and one half percent hydrogen peroxide by weight via a thirty six percent solution in water, and approximately three percent boric acid by weight via a thirty percent solution in water. In another variation of the seventh example formulation, the formulation is between sixty and eighty percent alkali silicate by weight, between zero (trace) and two percent non-ionic fluorocarbon surfactant by weight, between zero (trace) and five percent potassium carbonate by weight, between fifteen and twenty five percent hydrogen peroxide by weight, and between zero (trace) and five percent boric acid by weight. As noted above, any suitable alkali metal-silicate suitable can be used in the production of ceramic vacuum microspheres.

An eighth example formulation includes an alkali silicate, potassium methyl siliconate, a non-ionic fluorocarbon surfactant, an alkali carbonate, boric acid and urea. In one variation of the eighth example formulation, the formulation is approximately sixty eight percent alkali silicate by weight, approximately ten percent potassium methyl siliconate by weight, approximately two tenths of a percent non-ionic fluorocarbon surfactant by weight, approximately two and eight tenths percent alkali carbonate by weight, approximately three percent boric acid by weight via a three percent solution in water, and approximately sixteen percent urea by weight via a thirty percent solution in water. In another variation of the eighth example formulation, the formulation is between sixty and seventy five percent alkali silicate by weight, between five and fifteen percent potassium methyl siliconate by weight, between zero (trace) and one percent non-ionic fluorocarbon surfactant by weight, between zero (trace) and five percent alkali carbonate by weight, between zero (trace) and five percent boric acid by weight and between ten and twenty percent urea by weight. Both the alkali silicate and the alkali carbonate can include any of at least the following alkalis: lithium, sodium and/or potassium.

In each of the eight example formulations, one can partially or totally substitute for boric acid using an organic acetate, such as for example di-acetate, tri-acetate, and/or glycol-tri-acetate.

Given the example formulations described above as well as the systems and methods described herein, the inventor has found that the resultant product will range in density between five-hundredths of a gram per cubic centimeter to one and two tenths grams per cubic centimeter. The particle size of the resultant product ranges from approximately one hundred nanometers to as much as three hundred fifty microns.

Additionally, any of the example formulations described herein can be colored within a certain color spectrum and/or selection, including for example red, brown, black, gray, blue, green, yellow, and any mixtures thereof, i.e. violet. In one example methodology, the color pigment can be provided in a paste form and based upon iron oxide, although many other suitable pigments and/or coloring arrangements can be performed according to the present invention. In a variation of the example methodology, the concentration of the color pigment that can be added to the example formulations can range between fifteen and fifty-five percent by weight with respect to the weights of the solids in the respective formulation, although other ranges and/or concentrations are also usable in the present invention.

The spray dryer system used has both a top mounted atomizer rotary wheel and a side or bottom mounted dual fluid nozzle which may both be utilized at the same time. The atomizer wheel rotates with at speeds up to 63,000 rpm. This in turn creates very small particles within the entire heated spray chamber. The dual spray units are used in sequence within the heated spray chamber, such that while the top mounted rotating atomizer wheel is atomizing the solutions into submicronized sized hollow particles, the side bottom mounted dual fluid nozzle introduces other solutions that will counteract with the top sprayed particles and create an outer shell to the semi-fused particles created by the top mounted rotating wheel. Depending upon the choice of solution, the outer shell can make the sub-micron particles float in liquid, dissolve, semi-dissolve over extended time (i.e., time-release), or can make the spheres reactive.

With regards to the temperature ranges within the spray drying unit, there are two temperature zones, inlet and outlet. The inlet temperature should be within the range of 500 degrees C.-1200 degrees C. and the outlet temperature should be within the range of 150 degrees C.-350 degrees. These processing temperature chosen from these ranges are dependent upon the intended use of the microspheres and the degree of fusion that is desired.

The spray dryer is connected to a secondary heating unit, a rotary-tube-furnace or rotary kiln, or a vertical tube furnace with gravity feeding of the particles from the top of the tube, in order to finalize the total fusion of the ceramic-glass hollow vacuum sphere. This secondary heating unit is connected to the first stage heated spray dryer such that the spheres are under vacuum, typically at an average pressure of 1-5 millibars, such that sufficient outgassing occurs.

As a person skilled in the art will recognize from the previous detailed description and from the figures and claims, modifications and changes can be made to the preferred embodiments of the invention without departing from the scope of this invention defined in the following claims.

I claim:

1. A ceramic vacuum microsphere manufacturing process comprising the steps of providing a spray dryer having a top mounted atomizer rotary wheel and a side or bottom mounted dual fluid nozzle, forming microspheres by spraying solution from the top mounted atomizer rotary wheel and simultaneously coating said microspheres by spraying solution from said side or bottom mounted dual fluid nozzle, transferring said microspheres to a secondary heating unit, and drying said microspheres, all under vacuum of between 1 to 5 millibars.
